(19) United States
(12) Patent Application Publication
(10) Pub. No.: US 2026/0327112 A1
(43) Pub. Date: Oct. 22, 2026

(54) RESTORATION SYSTEM FOR FISH HABITATS

(71) Applicant: China Institute of Water Resources and Hydropower Research, Beijing (CN)

(72) Inventors: WEI HUANG, Beijing (CN); ZHUOWEI WANG, Beijing (CN); BEI ZHU, Beijing (CN); JINJIN GE, Beijing (CN)

(21) Appl. No.: 19/537,656

(22) Filed: Feb. 12, 2026

(30) Foreign Application Priority Data
Jul. 21, 2025 (CN) 202511004312.4

(51) Int. Cl. C02F 3/32; A01G 31/02; A01K 61/75; C02F 103/00; C02F 103/20

(52) U.S. Cl. CPC C02F 3/327; A01G 31/021; A01K 61/75; C02F 2103/007; C02F 2103/20

(57) ABSTRACT

Provided is a restoration system for fish habitats, which includes a repair traction component, a root amplification component is provided on the repair traction component. The root amplification component is configured to amplify roots of ecological plants; the repair traction component is provided with a positioning component, and the positioning component is configured to locate the root amplification component. The repair traction component is provided with an anti-gnawing component; the anti-gnawing component is provided with an anti-pull part. The use of the root amplification components in combination with the repair traction component facilitates the expansion of the root system through expansion holes. The larger diameter of the expansion holes can reduce rooting resistance, and with a positioning control of the positioning component, it can prevent leakage of coconut fiber matrix during early plant growth.

### CROSS-REFERENCE TO RELATED APPLICATIONS

This application claims priority to Chinese Patent Application No. 202511004312.4, filed on Jul. 21, 2025, which is hereby incorporated by reference in its entirety.

### TECHNICAL FIELD

The present disclosure relates to the field of ecological floating island restoration technologies, and in particular, to a restoration system for fish habitats.

### BACKGROUND

In the restoration system of fish habitats, ecological floating islands are widely used. The ecological floating islands are a commonly configured restoration system for water purification. Aquatic plants on ecological floating islands, such as Acorus calamus, Canna officinalis, and Water Celery, have roots that penetrate deep into the water and directly absorb excess nitrogen, phosphorus, and other nutrient rich substances in the fishpond, playing a role in the restoration of fish habitats. Currently, the restoration system of fish habitats is not easy to automatically control and increase the expansion of plant roots. Usually, a mesh structure tray is configured to support substrates such as coconut fibers to prevent substrate leakage, which restricts the expansion and growth of plant roots. At the same time, it is not easy to protect plants from excessive feed from fish. Aquatic plant roots contain starch, soluble sugars, etc., which are natural feed for omnivorous fish. When the wind is strong or the water is changing for the ecological floating island, although floating islands can adapt to the water surface, plant roots are well-developed and can take root at the bottom or slopes of fishponds. When the ecological floating island falls or exceeds the displacement limit, it is easy to be pulled by the roots, thereby causing damage to the plants.

Therefore, a restoration system for fish habitats is provided.

### SUMMARY

The purpose of the present disclosure is to provide a restoration system for fish habitats, in order to solve the problem of the current fish habitat restoration system proposed in the background technology that is not conducive to automatically controlling the expansion of plant roots and preventing plant roots from being pulled.

To achieve the above objectives, the present disclosure provides the following technical solution: a restoration system for fish habitats, including: a repair traction component, where a root amplification component is provided on the repair traction component, the root amplification component is configured to amplify roots of ecological plants; the repair traction component is provided with a positioning component, and the positioning component is configured to locate the root amplification component; the repair traction component is provided with an anti-gnawing component; the anti-gnawing component is provided with an anti-pull part, and the anti-pull part is configured to adhere to the anti-gnawing component for cleaning; the repair traction component is provided with anti-pull detection components; the anti-pull detection components are attached to the anti-pull part; the anti-pull detection components are configured to prevent the repair traction component from shaking and pulling the ecological plants; the repair traction component includes a fixing ring, limit ropes, and a circular floating box, where the fixing ring is fixedly provided with the limit ropes; tops of the limit ropes are fixedly provided with the circular floating box, and the circular floating box is configured to float on a water surface.

In some embodiments of the present disclosure, the repair traction component further includes a water inlet pipe, a plant support plate, expansion holes, and a sliding installation cylinder; the circular floating box is fixedly provided with the water inlet pipe; the water adding pipe is externally connected to a water pump; the fixing ring is fixedly provided with the plant support plate, and the plant support plate is provided with six rows of arc-shaped slot holes; the plant support plate is provided with six rows of expansion holes; the expansion holes are configured to facilitate root penetration; the plant support plate is fixedly provided with the sliding installation cylinder, and a middle of the sliding installation cylinder is a hexagonal hole.

In some embodiments of the present disclosure, the root amplification component includes a lifting column, baffles, and a limiting column; where the lifting column is a hexagonal column; the lifting column is slidably inserted onto the sliding installation cylinder; a bottom of the lifting column is fixedly provided with six baffles, each of the six baffles respectively covers and adhere to the six rows of expansion holes; a limiting column is fixedly provided on the lifting column; the limiting column is provided above the sliding installation cylinder; one side of the lifting column is provided with an insertion hole.

In some embodiments of the present disclosure, the positioning component includes a plug-in shaft and a traction rope; where the plug-in shaft is slidably inserted into the sliding installation cylinder; one end of the plug-in shaft is inserted into the insertion hole provided on the side of the lifting column; the plug-in shaft is sleeved with a tension spring, and the tension spring on the plug-in shaft is connected between the plug-in shaft and the sliding installation cylinder; the traction rope is fixedly provided on the plug-in shaft; the traction rope is configured for handheld and pulling the plug-in shaft.

In some embodiments of the present disclosure, the anti-gnawing component includes a protective mesh tube, a lower support ring, reinforcement rods, and a lower flow plate; the protective mesh tube is fixedly provided at a bottom of the circular floating box; the protective mesh tube is provided with a mesh structure; a bottom of the protective mesh tube is fixedly provided with the lower support ring, and four reinforcement rods are fixedly provided on the lower support ring, tops of the four reinforcement rods are fixedly provided at a bottom of the circular floating box; the lower support ring is fixedly provided with the lower flow plate, and the lower flow plate is provided with a slot hole; the protective mesh tube is provided below the plant support plate.

In some embodiments of the present disclosure, the anti-pull part includes a drive motor, return rotating rods, and a rotating ring; where the drive motor is fixedly provided on the lower flow plate; the drive motor is configured for waterproof treatment; an output shaft of the drive motor passes through the lower flow plate; two return rotation rods are fixedly provided on the output shaft of the drive motor; the two lower return levers are fixedly provided with the rotating ring; the rotating ring is rotatably sleeved to the lower support ring; two lower return levers are respectively provided with bristles and blades; the bristles and blades on the two lower return levers are respectively attached to the lower flow plate.

In some embodiments of the present disclosure, the anti-pull part further includes external return rods, two external return rods are fixedly provided on the rotating ring, and bristles and blades are respectively provided on the two external return rods; the bristles and blades on the two external return rods are respectively attached to an outer side of the protective mesh tube; blades on the two lower return levers and the two external return rods are respectively configured to cut off an exposed root system.

In some embodiments of the present disclosure, the anti-pull detection components include outer limit rods, correction propulsion shafts, and bonding plates; the outer limit rods are fixedly provided on the fixing ring, and structures on the outer limit rods are the same; there are two correction propulsion shafts slidably inserted into the outer limit rods; the two correction propulsion shafts are respectively sleeved with tension springs, and the tension springs on the two correction propulsion shafts are connected between the correction propulsion shafts and the outer limit rods; the two correction propulsion shafts are fixedly provided with the bonding plates, and one side of the bonding plates is attached to an outer side of the rotating ring.

In some embodiments of the present disclosure, the anti-pull detection components further include a drop detection plate, and the drop detection plate is fixedly provided on one side of the bonding plates; tops of the bonding plates are sloping structures; the bonding plates are provided at a bottom of the rotating ring.

In some embodiments of the present disclosure, the anti-pull detection components further include a control telescopic shaft and micro switches, and the outer limit rods are slidably inserted with the control telescopic shaft; the control telescopic shaft is sleeved with a tension spring, and the tension spring on the control telescopic shaft is connected between the control telescopic shaft and the outer limit rods; one end of the control telescopic shaft is fixedly provided with the micro switches; there is a gap between the micro switches and the bonding plates; the micro switches are electrically connected to the drive motor.

Compared with the existing technology, the beneficial effects of the present disclosure are as follows.

The present disclosure uses the root amplification component in combination with the repair traction component to facilitate the expansion of root systems through amplification holes. The aperture of the amplification holes is larger, which can reduce rooting resistance. With the positioning control of the positioning component, it can prevent leakage of coconut fiber matrix during the initial growth of plants. Because plants need to be planted on the plant support plate and coconut fiber matrix needs to be laid, the widths of the through grooves on the plant support plate cannot be too large, otherwise it is easy to cause leakage of coconut fiber matrix. By using baffles, after the distribution and growth of plant roots, the roots can wrap around each other, and the coconut fiber matrix can be integrated, which can control the downward movement of the baffles, facilitate the expansion of plant roots, reduce obstruction, and improve the effect of water restoration.

The use of the anti-pull detection component can achieve elastic control of the stability of the circular floating box. At the same time, in the event of excessive water discharge in the fishpond or strong environmental wind, which causes the circular floating box to fall excessively or shake excessively left and right, it can automatically control the cutting of the rooted roots, without affecting the normal growth of plants, avoiding tearing and other problems. The structure is more reasonable, improving wind resistance and water change safety, without affecting the flexibility of the relocation position of the structure.

The use of the anti-pull part can clean the protective net tube and the lower flow plate, ensuring water circulation and water exchange. At the same time, it can facilitate the staff to add water to the fishpond in the protective net tube, using the protective net tube to buffer the water flow and reduce stress interference on fish.

### BRIEF DESCRIPTION OF DRAWINGS

FIG. 1 is a schematic diagram of an overall structure of a restoration system for fish habitats according to the present disclosure.

FIG. 2 is a sectional view of an internal structure of the restoration system for fish habitats according to the present disclosure.

FIG. 3 is a schematic diagram of a bottom structure of the restoration system for fish habitats according to the present disclosure.

FIG. 4 is a schematic structural diagram of a repair traction component of the present disclosure.

FIG. 5 is a schematic structural diagram of a root amplification component of the present disclosure.

FIG. 6 is an enlarged structural view of region B in FIG. 5 of the present disclosure.

FIG. 7 is a schematic structural diagram of an anti-gnawing component of the present disclosure.

FIG. 8 is a schematic structural diagram of an anti-pull part of the present disclosure.

FIG. 9 is a schematic structural diagram of an anti-pull detection component of the present disclosure.

FIG. 10 is an enlarged structural view of region C in FIG. 3 of the present disclosure.

FIG. 11 is a partial structural sectional view of the restoration system for fish habitats according to the present disclosure.

Numeral reference: 1- repair traction component; 101- fixing ring; 102- limit rope; 103- circular floating box; 104- water inlet pipe; 105- plant support plate; 106- expansion hole; 107- sliding installation cylinder; 2- root amplification component; 201-lifting column; 202- baffle; 203- limiting column; 3- positioning component; 301- plug-in shaft; 302- traction rope; 4- anti-gnawing component; 401- protective mesh tube; 402- lower support ring; 4021- reinforcement rod; 403- lower flow plate; 5- anti-pull part; 501- drive motor; 502- lower return lever; 503- rotating ring; 504- external return rod; 6- anti-pull detection component; 601- outer limit rod; 602- correction propulsion shaft; 603- bonding plate; 604- drop detection board; 605- control telescopic shaft; 606- micro switch.

### DESCRIPTION OF EMBODIMENTS

Below, the technical solutions in the embodiments of the present disclosure will be clearly and completely described in combination with the accompanying drawings. Obviously, the described embodiments are only a part of the embodiments of the present disclosure, not all of them. Based on the embodiments of the present disclosure, all other embodiments obtained by those skilled in the art without creative work are within the protection scope of the present disclosure.

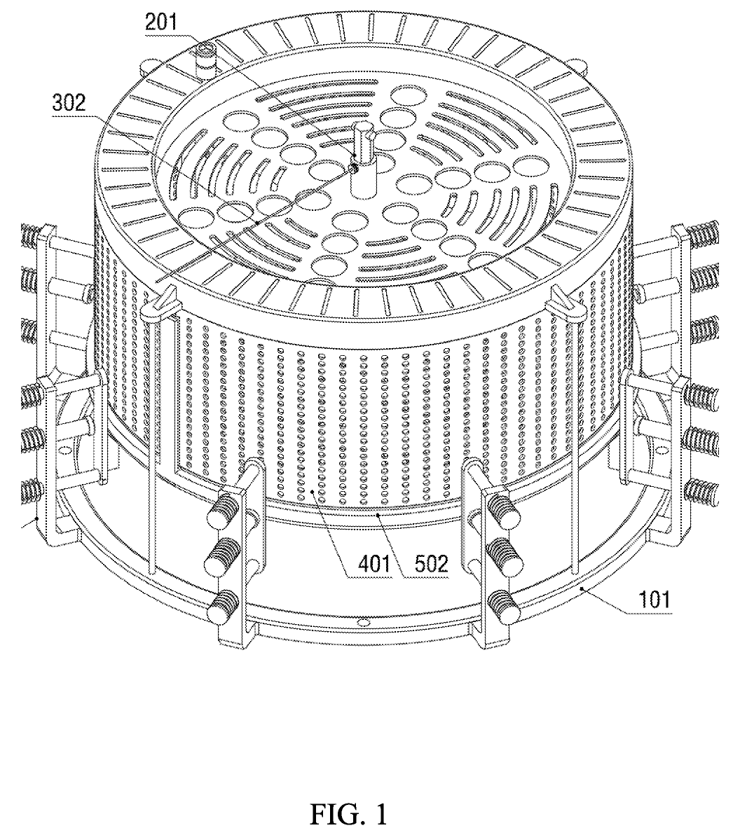

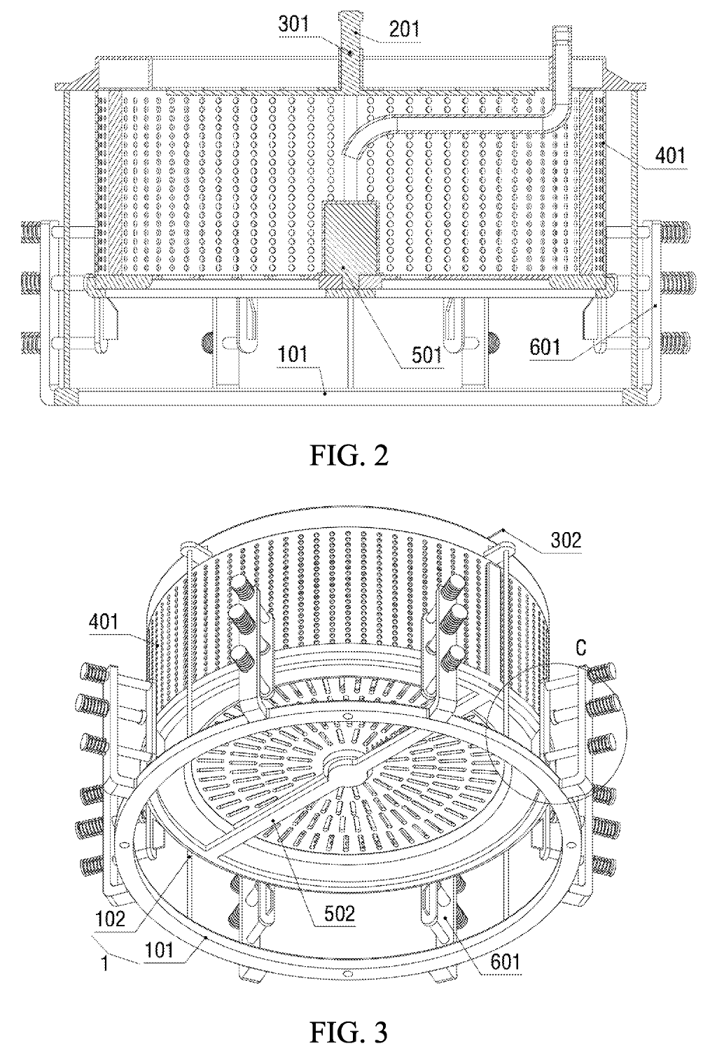

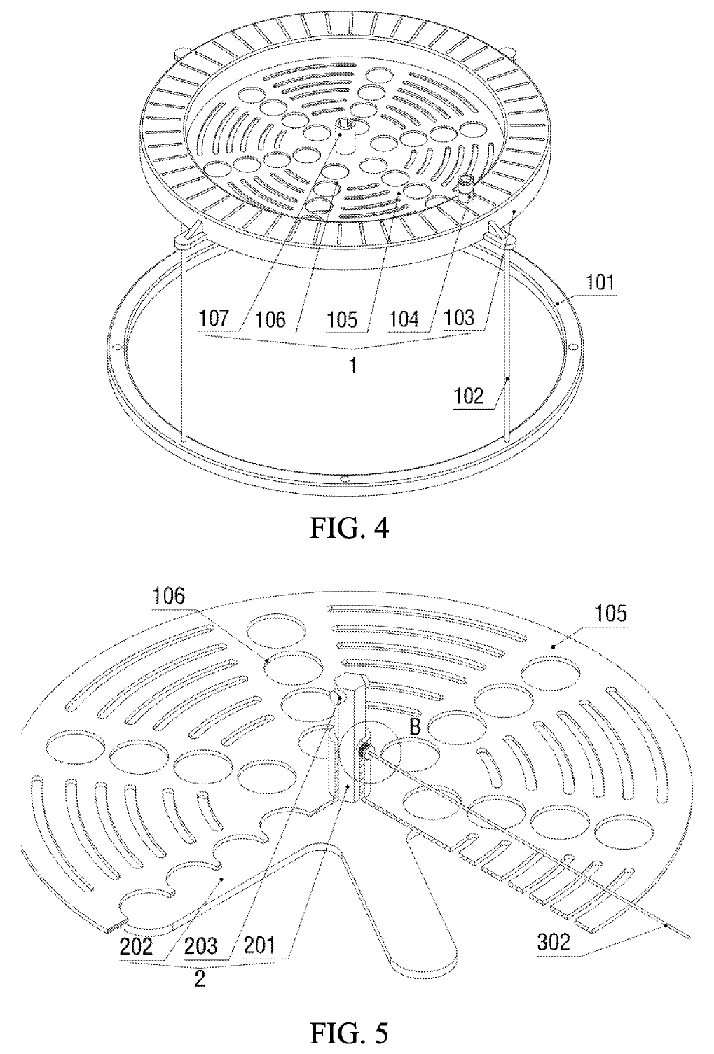

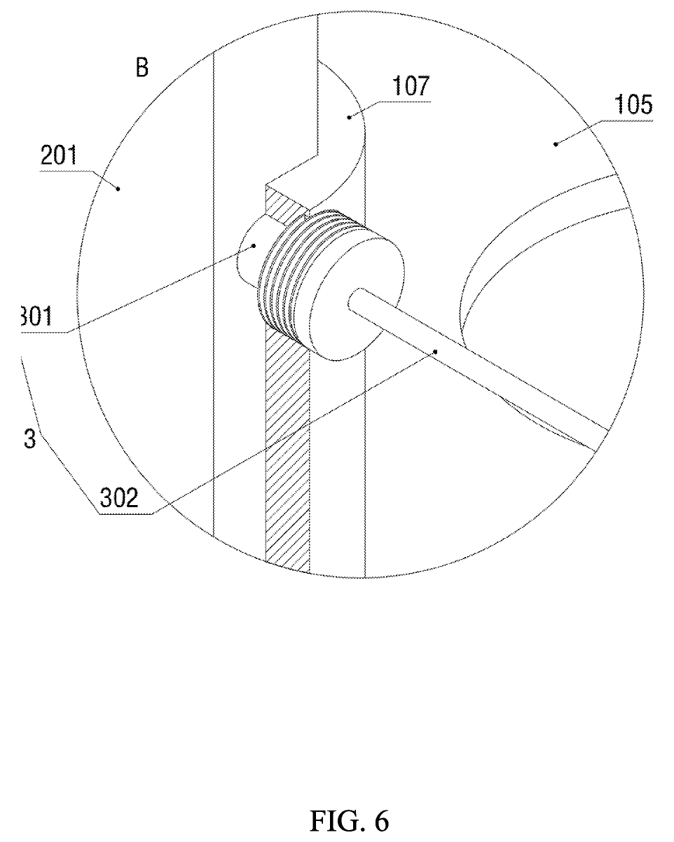

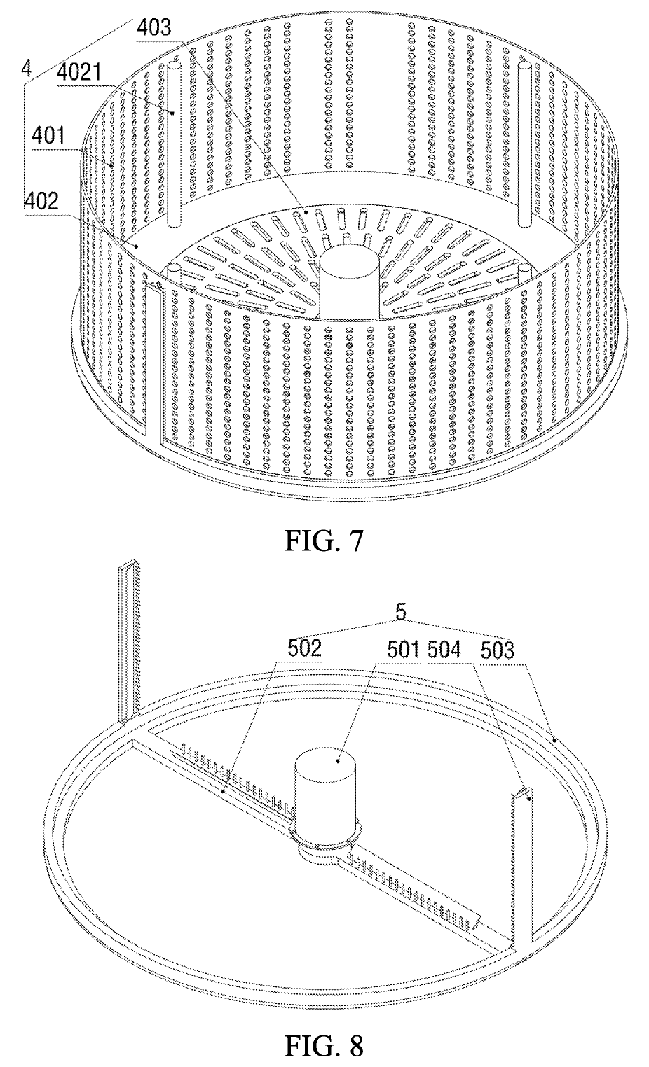

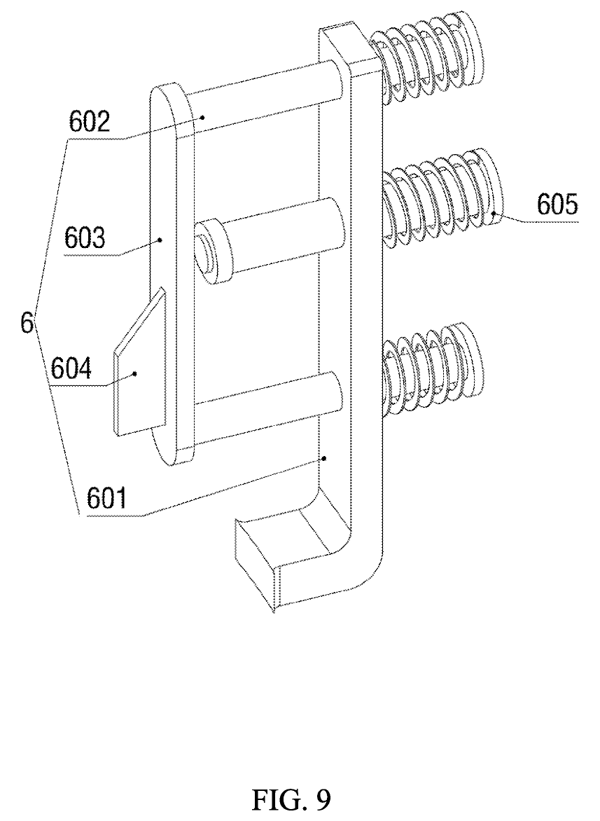

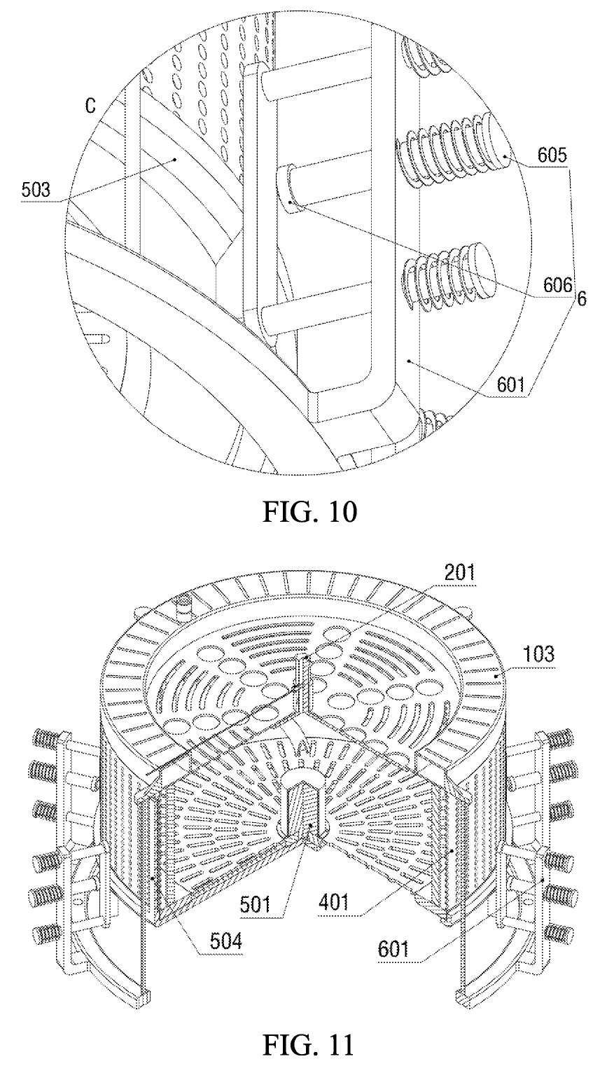

Embodiment 1: please refer to FIGS. 1 to 11.

The present disclosure provides a technical solution: a restoration system for fish habitats, including a repair traction component 1, where a root amplification component 2 is provided on the repair traction component 1, and the root amplification component 2 is configured to amplify roots of ecological plants; a positioning component 3 is provided on the repair traction component 1; the positioning component 3 is configured to locate the root amplification component 2; an anti-gnawing component 4 is provided on the repair traction component 1; the anti-gnawing component 4 is provided with an anti-pull part 5; the anti-pull part 5 is configured to adhere to the anti-gnawing component 4 for cleaning; the repair traction component 1 is provided with anti-pull detection components 6; the anti-pull detection components 6 are attached to the anti-pull part 5; the anti-pull detection components 6 are configured to prevent the repair traction component 1 from shaking and pulling the ecological plants. The repair traction component 1 includes a fixing ring 101, limit ropes 102, and a circular floating box 103. The limit ropes 102 are fixedly provided with the fixing ring 101; tops of the limit ropes 102 are fixedly provided with the circular floating box 103, and the circular floating box 103 is configured to float on a water surface.

Where the repair traction component 1 further includes a water inlet pipe 104, a plant support plate 105, expansion holes 106, and a sliding installation cylinder 107. The circular floating box 103 is fixedly provided with the water inlet pipe 104. There is an external water pump connected to the water inlet pipe 104; the plant support plate 105 is fixedly provided on the fixing ring 101, and the plant support plate 105 is provided with six rows of arc-shaped slot holes. There are six rows of expansion holes 106 on the plant support plate 105. The expansion holes 106 are configured to facilitate root penetration. The sliding installation cylinder 107 is fixedly provided on the plant support plate 105, and a middle of the sliding installation cylinder 107 is a hexagonal hole. The root amplification component 2 includes a lifting column 201, baffles 202, and a limiting column 203. The lifting column 201 is a hexagonal column. The lifting column 201 is slidably inserted onto the sliding installation cylinder 107. Six baffles 202 are fixedly provided at a bottom of the lifting column 201, and each of the six baffles 202 covers and adheres to the six rows of expansion holes 106. A limiting column 203 is fixedly provided on the lifting column 20. The limiting column 203 is provided above the sliding installation cylinder 107. There is an insertion hole on one side of the lifting column 201. The positioning component 3 includes a plug-in shaft 301 and a traction rope 302. The plug-in shaft 301 is slidably inserted into the sliding installation cylinder 107. One end of the plug-in shaft 301 is inserted into the insertion hole provided on the side of the lifting column 201. The plug-in shaft 301 is sleeved with a tension spring, and the tension spring on the plug-in shaft 301 is connected between the plug-in shaft 301 and the sliding installation cylinder 107. The traction rope 302 is fixedly provided on the plug-in shaft 301. The traction rope 302 is configured for handheld and pulling the plug-in shaft 301. The root amplification component 2 is used in combination with the repair traction component 1 to facilitate an expansion of the root system through the expansion holes 106. The apertures of the expansion holes 106 are larger, which can reduce rooting resistance. Combined a positioning control of the positioning component 3, because plants need to be planted on the plant support plate 105, coconut fiber matrix needs to be laid. Therefore, widths of through grooves on the plant support plate 105 cannot be too large, otherwise it is easy to cause leakage of coconut fiber matrix. By using the baffles 202, after the distribution and growth of plant roots, the roots can be intertwined with each other, and the coconut fiber matrix can be integrated. The baffles 202 can be controlled to move downwards, which facilitates the expansion of the plant roots, reduces obstruction, improves the water body repair effect, prevents the initial leakage of matrix from affecting plant growth, and facilitates the downward movement of roots. The coconut fiber substrate is laid on the plant support plate 105. Currently, coconut fiber is commonly used as the substrate because the coconut fiber itself is filamentous, which can facilitate the formation of a whole after hydroponic plant planting, increase stability, and improve wind resistance. At the same time, coconut fiber is taken from an outer shell of the coconut, mainly composed of cellulose, which will not cause pollution. Pulling the traction rope 302 drives the plug-in shaft 301 to be pulled out from the lifting column 201. The lifting column 201 and the baffles 202 will fall under their own weight. At this time, the baffles 202 will no longer cover the expansion holes 106. At this time, the coconut fiber is distributed by the root system, and with the filamentous coconut fiber, the coconut fiber will not leak. At this time, the expansion holes 106 with a larger aperture can be easily penetrated by the root system, and the root system will also fill the expansion holes 106 as it expanded, and which facilitates the distribution of nutrients in water bodies for hydroponic cultivation, gradually replacing the coconut fiber.

Where the anti-gnawing component 4 includes a protective mesh tube 401, a lower support ring 402, reinforcement rods 4021, and a lower flow plate 403. The protective mesh tube 401 is fixedly provided at a bottom of the circular floating box 103. The protective mesh tube 401 is provided with a mesh structure. A bottom of the protective mesh tube 401 is fixedly provided with the lower support ring 402, and four reinforcement rods 4021 are fixedly provided on the lower support ring 402. Tops of the four reinforcement rods 4021 are fixedly provided at a bottom of the circular floating box 103. The lower flow plate 403 is fixedly provided with the lower support ring 402, and a slot hole is provided on the lower flow plate 403. The mesh holes on the protective mesh tube 401 and the slot holes on the lower flow plate 403 can prevent root systems from accumulating inside the protective mesh tube 401, facilitating the outward growth and diffusion of root systems, and providing an outward growth path. The protective mesh tube 401 is provided below the plant support plate 105. The anti-pull part 5 includes a drive motor 501, lower return levers 502, and a rotating ring 503. The drive motor 501 is fixedly provided on the lower flow plate 403. The drive motor 501 is configured for waterproof treatment. An output shaft of the drive motor 501 passes through the lower flow plate 403. Two lower return levers 502 are fixedly provided on the output shaft of the drive motor 501. The two lower return levers 502 are fixedly provided with the rotating ring 503. The rotating ring 503 is rotatably sleeved to the lower support ring 402. The two lower return levers 502 are respectively provided with bristles and blades. The bristles and blades on the two lower return levers 502 are respectively attached to the lower flow plate 403. The drive motor 501 is externally connected to a switch. The anti-pull part 5 further includes external return rods 504, two external return rods 504 are fixedly provided on the rotating ring 503, and bristles and blades are respectively provided on the two external return rods 504. The bristles and blades on the two external return rods 504 are respectively attached to an outer side of the protective mesh tube 401. The blades on the two lower return levers 502 and the two external return rods 504 are configured to cut off an exposed root system, and the anti-gnawing component 4 is configured to protect the plant root system. This can prevent a large amount head ends of the plant root system being gnawed, ensure that the length of the root system does not affect plant growth, and ensure that the length of the root system can meet the water restoration effect. The structure is simple and reasonable. At the same time, with the help of the anti-pull part 5, it can clean the protective mesh tube 401 and the lower flow plate 403, ensuring the water circulation and water exchange. At the same time, it can facilitate a staff adding water to the fishpond in the protective mesh tube 401. The protective mesh tube 401 is configured to buffer the water flow and reduce stress interference on fish.

Embodiment 2, based on embodiment 1, the anti-pull detection components 6 include outer limit rods 601, correction propulsion shafts 602, and bonding plates 603. The outer limit rods 601 are fixedly provided on the fixing ring 101, and the structure on the outer limit rods 601 are the same. There are two correction propulsion shafts 602 slidably inserted into the outer limit rods 601. The two correction propulsion shafts 602 are respectively sleeved with tension springs, and the tension springs on the two correction propulsion shafts 602 are connected between the two correction propulsion shafts 602 and the outer limit rod 601. The two correction propulsion shafts 602 are fixedly provided with the bonding plates 603, and one side of the bonding plates 603 is attached to an outer side of the rotating ring 503. The anti-pull detection components 6 further include a drop detection plate 604, and the drop detection plate 604 is fixedly provided on one side of the bonding plates 603. Tops of the bonding plates 603 are sloping structures; the bonding plates 603 are provided at a bottom of the rotating ring 503. The anti-pull detection components 6 further include a control telescopic shaft 605 and micro switches 606, the control telescopic shaft 605 is slidably inserted on the outer limit rods 601. The control telescopic shaft 605 is sleeved with a tension spring, and the tension spring on the control telescopic shaft 605 is connected between the control telescopic shaft 605 and the outer limit rods 601. The micro switches 606 are fixedly provided at one end of the control telescopic shaft 605. There is a gap between the micro witches 606 and the bonding plates 603. The micro switches 606 are electrically connected to the drive motor 501, and the anti-pull detection components 6 are configured to achieve elastic control of the circular floating box 103 to improve stability. At the same time, when the water in the fishpond is excessively drained or the environmental wind is strong, the circular floating box 103 is caused to fall excessively and shake excessively left and right, it can automatically detect. Because when the circular floating box 103 falls or shakes excessively, the root system generated in the protective mesh tube 401 and the lower flow plate 403 will also root at the bottom or slope of the fishpond. Once the circular floating box 103 shakes or falls, it is easy to pull the plant root system. When the plant root system is pulled excessively, it will shake, further increasing the hidden danger of pulling the plant head and affecting plant growth. This structure can automatically control the cutting of rooted root system. It does not affect the normal growth of plants, avoids problems such as tearing, and has a more reasonable structure, enhances wind resistance and water replacement safety, without affecting the flexibility of the structure’s relocation position, and without affecting the adaptability of the circular floating box 103 to water level rise and fall and movement position. Because the fishpond itself has a drainage system that prevents rainwater from flowing back, excessive water level rise will not occur, and the circular floating box 103 will not move up excessively, the plant roots are caused to be pulled. In actual use, the fixing ring 101 is balanced at the bottom of the fishpond, and the length of the four limit ropes 102 is arranged according to demand. Once the environmental wind is too strong, the moving pressure of the circular floating box 103 will be greater than tension spring force on each of the correction propulsion shafts 602 in the moving direction. At this time, when the displacement of the circular floating box 103 on the water surface exceeds the standard, the bonding plates 603 on one side of the moving direction will be squeezed and shrunk, and the backward shrinkage exceeds the standard, and it will squeeze the micro switches 606, and similarly, once there is excessive water discharge in the fishpond, the circular floating box 103 will adapt to the descent of the water surface, the rotating ring 503 is driven to descend together and squeeze the drop detection board 604. At this time, the bonding plates 603 will retract and approach and squeeze the micro switches 606, the drive motor 501 is controlled to start and cut off the root system, thereby avoiding the root system rooted in the fishpond wall from being excessively pulled when the circular floating box 103 descends. The structure is simple and reasonable.

The working principle of this embodiment: firstly, the structure is placed in the fishpond, and the fixing ring 101 is weighed at a bottom of the fishpond. The lengths of the four limit ropes 102 are arranged according to the needs. The coconut fiber matrix is laid on the plant support plate 105, and the baffles 202 are blocked at the bottom of the expansion holes 106. At this time, the coconut fiber matrix will not leak, but will only wet through the six rows of arc-shaped groove holes on the plant support plate 105. As the plants grow on the coconut fiber on the plant support plate 105, when the plant roots grow and intertwine with each other, the distribution of plant roots in the coconut fiber matrix can be observed regularly. After the coconut fiber is in a whole state, the traction rope 302 is manually pulled to drive the plug-in shaft 301 to be pulled out from the lifting column 201, the lifting column 201 and the baffles 202 will fall under their own weight. At this point, the baffles 202 no longer block the expansion holes 106. At this point, the coconut fiber is distributed by the root system, and with the addition of the filamentous coconut fiber, the coconut fiber will not leak excessively. The expansion holes 106 with a larger aperture can be easily penetrated by the root system, and as the root system grows, it will also fill the expansion holes 106, rendering it easier to distribute nutrients in the water for hydroponic cultivation. When the water level is normal and the environment is stable, the bonding plates 603 can be elastically attached to the rotating ring 503 under the pull of the tension spring on the correction propulsion shafts 602, improving the stability of the circular floating box 103. Once the environmental wind is too strong, the moving pressure of the circular floating box 103 is greater than the tension spring force on each of the correction propulsion shafts 602 in the moving direction. And when the displacement of the circular floating box 103 on the water surface exceeds the standard, each of the bonding plates 603 on one side of the moving direction are compressed and retracted. If the retraction exceeds the standard, the micro switches 606 will be compressed. By setting a tension spring on the control telescopic shaft 605, it can ensure that there is still a certain amount of elastic displacement after the micro switches 606 are compressed. When any one micro switch 606 is compressed, the drive motor 501 will be turned on, and the lower return levers 502 and the external return rods 504 are driven to rotate, the blades on the lower return levers 502 and the external return rods 504 are driven to cut off the root system on the outer side of the protective mesh tube 401 and the lower flow plate 403, thereby avoiding the root system from being rooted in the soil and causing entanglement. Similarly, once there is excessive water in the fishpond, the circular floating box 103 will descend to adapt to the water surface, the rotating ring 503 is driven to lower and squeeze the drop detection board 604 together. At this time, the bonding plates 603 will retract and approach the micro switches 606, the drive motor 501 is controlled to start cutting off the root system, avoiding the root system rooted in the fishpond wall from being excessively pulled when the circular floating box 103 descends.

When water needs to be added after the fish pond is drained, the lower return lever 502 and the external return rods 504 are driven to rotate by starting the drive motor 501, which drives the brushes on the lower return levers 502 and the external return rods 504 to wipe the protective mesh tube 401 and the lower flow plate 403. At this time, the water pump connected to the water inlet pipe 104 can be started to supply water and achieve the water adding work. During normal use, the protective mesh tube 401 and the lower flow plate 403 also play a role in preventing the plant head from being gnawed on the outside the plant root system, ensuring that fish can only gnaw on tail ends of the plants.

It should be noted that in this specification, relational terms such as first and second are only configured to distinguish one entity or operation from another, and do not necessarily require or imply any actual relationship or order between these entities or operations. Moreover, terms “including”, “containing”, or any other variation thereof are intended to encompass non-exclusive inclusion, such that a process, method, item, or device that includes a series of elements includes not only those elements, but also other elements not explicitly listed, or elements inherent to such process, method, item, or device.

Although the embodiments of the present disclosure have been shown and described, it will be understood by those skilled in the art that various changes, modifications, substitutions, and variations can be made to these embodiments without departing from the principles and spirit of the present disclosure. The scope of the present disclosure is limited by the appended claims and their equivalents.

What is claimed is:

1. A restoration system for fish habitats, comprising: a repair traction component, wherein a root amplification component is provided on the repair traction component, the root amplification component is configured to amplify roots of ecological plants; the repair traction component is provided with a positioning component, and the positioning component is configured to locate the root amplification component;
the repair traction component is provided with an anti-gnawing component; the anti-gnawing component is provided with an anti-pull part, and the anti-pull part is configured to adhere to the anti-gnawing component for cleaning;
the repair traction component is provided with anti-pull detection components; the anti-pull detection components are attached to the anti-pull part; the anti-pull detection components are configured to prevent the repair traction component from shaking and pulling the ecological plants;
the repair traction component comprises a fixing ring, limit ropes, and a circular floating box, wherein the fixing ring is fixedly provided with the limit ropes; tops of the limit ropes are fixedly provided with the circular floating box, and the circular floating box is configured to float on a water surface;
the repair traction component further comprises a water inlet pipe, a plant support plate, expansion holes, and a sliding installation cylinder; the circular floating box is fixedly provided with the water inlet pipe; the water adding pipe is externally connected to a water pump; the fixing ring is fixedly provided with the plant support plate, and the plant support plate is provided with six rows of arc-shaped slot holes; the plant support plate is provided with six rows of expansion holes; the expansion holes are configured to facilitate root penetration; the plant support plate is fixedly provided with the sliding installation cylinder, and a middle of the sliding installation cylinder is a hexagonal hole;
the root amplification component comprises a lifting column, baffles, and a limiting column; wherein the lifting column is a hexagonal column; the lifting column is slidably inserted onto the sliding installation cylinder; a bottom of the lifting column is fixedly provided with six baffles, each of the six baffles respectively covers and adhere to the six rows of expansion holes; a limiting column is fixedly provided on the lifting column; the limiting column is provided above the sliding installation cylinder; one side of the lifting column is provided with an insertion hole;
the positioning component comprises a plug-in shaft and a traction rope; wherein the plug-in shaft is slidably inserted into the sliding installation cylinder; one end of the plug-in shaft is inserted into the insertion hole provided on the side of the lifting column; the plug-in shaft is sleeved with a tension spring, and the tension spring on the plug-in shaft is connected between the plug-in shaft and the sliding installation cylinder; the traction rope is fixedly provided on the plug-in shaft; the traction rope is configured for handheld and pulling the plug-in shaft;
the anti-gnawing component comprises a protective mesh tube, a lower support ring, reinforcement rods, and a lower flow plate; the protective mesh tube is fixedly provided at a bottom of the circular floating box; the protective mesh tube is provided with a mesh structure; a bottom of the protective mesh tube is fixedly provided with the lower support ring, and four reinforcement rods are fixedly provided on the lower support ring, tops of the four reinforcement rods are fixedly provided at a bottom of the circular floating box; the lower support ring is fixedly provided with the lower flow plate, and the lower flow plate is provided with a slot hole; the protective mesh tube is provided below the plant support plate;
the anti-pull part comprises a drive motor, return rotating rods, and a rotating ring; wherein the drive motor is fixedly provided on the lower flow plate; the drive motor is configured for waterproof treatment; an output shaft of the drive motor passes through the lower flow plate; two return rotation rods are fixedly provided on the output shaft of the drive motor; the two lower return levers are fixedly provided with the rotating ring; the rotating ring is rotatably sleeved to the lower support ring; two lower return levers are respectively provided with bristles and blades; the bristles and blades on the two lower return levers are respectively attached to the lower flow plate;
the anti-pull detection components comprise outer limit rods, correction propulsion shafts, and bonding plates; the outer limit rods are fixedly provided on the fixing ring, and structures on the outer limit rods are the same; there are two correction propulsion shafts slidably inserted into the outer limit rods; the two correction propulsion shafts are respectively sleeved with tension springs, and the tension springs on the two correction propulsion shafts are connected between the correction propulsion shafts and the outer limit rods; the two correction propulsion shafts are fixedly provided with the bonding plates, and one side of the bonding plates is attached to an outer side of the rotating ring.

2. The restoration system for fish habitats according to claim 1, wherein the anti-pull part further comprises external return rods, two external return rods are fixedly provided on the rotating ring, and bristles and blades are respectively provided on the two external return rods; the bristles and blades on the two external return rods are respectively attached to an outer side of the protective mesh tube; blades on the two lower return levers and the two external return rods are respectively configured to cut off an exposed root system.

3. The restoration system for fish habitats according to claim 1, wherein the anti-pull detection components further comprise a drop detection plate, and the drop detection plate is fixedly provided on one side of the bonding plates; tops of the bonding plates are sloping structures; the bonding plates are provided at a bottom of the rotating ring.

4. The restoration system for fish habitats according to claim 3, wherein the anti-pull detection components further comprise a control telescopic shaft and micro switches, and the outer limit rods are slidably inserted with the control telescopic shaft; the control telescopic shaft is sleeved with a tension spring, and the tension spring on the control telescopic shaft is connected between the control telescopic shaft and the outer limit rods; one end of the control telescopic shaft is fixedly provided with the micro switches; there is a gap between the micro switches and the bonding plates; the micro switches are electrically connected to the drive motor.
